(19) United States
(12) Patent Application Publication
(10) Pub. No.: US 2002/0030176 A1
(43) Pub. Date: Mar. 14, 2002

(54) Freeze-protected, firefighting foam composition

(76) Inventors: Daniel J. Shaffer, Reading, PA (US); Robert E. Gensemer, Denver, PA (US)

Correspondence Address: Richard A. Paikoff, DUANE, MORRIS & HECKSCHER LLP, One Liberty Place, Philadelphia, PA, 19103-7396, US

(21) Appl. No.: 09/758,878

(22) Filed: Jan. 11, 2001

Related U.S. Application Data
(60) Provisional application No. 60/184,536, filed on Feb. 24, 2000.

(51) Int. Cl. A62D 1/00; A62C 2/00

(52) U.S. Cl. 252/3; 252/4

(57) ABSTRACT

A composition that produces a film forming foam for firefighting is disclosed. The composition comprises an amount, effective for the intended purpose, of a biodegradable mixture of an alkali metal sulfate, a fluorinated polymer, propylene glycol and water.

### CROSS REFERENCE TO RELATED APPLICATION

This application claims the priority of copending Provisional Patent Application Ser. No. 60/184,536, filed Feb. 24, 2000.

### BACKGROUND OF THE INVENTION

Firefighting foam concentrates are mixtures of foaming agents, solvents and other additives. These concentrates are intended to be mixed with water usually at either a 3% or 6% (i.e., full strength) concentration; the resulting solution is then foamed by mechanical means and the foam is projected onto the surface of a burning liquid.

A particular class of firefighting foam concentrates is known as an aqueous film-forming foam (AFFF or AF³) AFFF concentrates have the quality of being able to spread an aqueous film on the surface of hydrocarbon liquids, enhancing the speed of extinguishment. This is made possible by the perfluoroalkyl surfactants contained in the AFFF. These surfactants produce very low surface tension values in solution (15-20 dynes cm⁻¹) which permit the solution to spread on the surface of the hydrocarbon liquids.

AFFF foams are not effective on water soluble fuels, such as alcohols and the lower ketones and esters, as the foam is dissolved and destroyed by the fuel. There is a sub-class of AFFF foam concentrates known as alcohol resistant AFFF (ARAFFF or ARAF³). ARAFFF concentrates contain a water soluble polymer that precipitates on contact with a water soluble fuel, providing a protective layer between the fuel and the foam. ARAFFF foams are effective on both hydrocarbons and water soluble fuels.

Typical AFFF concentrates contain one or more perfluoroalkyl surfactants which may be anionic, cationic, nonionic or amphoteric, one or more non-fluorinated surfactants which may be anionic, cationic, amphoteric or nonionic, solvents such as glycols and/or glycol ethers and minor additives such as chelating agents, pH buffers, corrosion inhibitors and the like. Such compositions are known in the art.

ARAFFF concentrates are essentially the same as AFFF's, with only the addition of a water soluble polymer. These compositions are disclosed in U.S. Pat. Nos. 4,060,489, 4,149,599 and 4,387,032.

We have unexpectedly discovered that a particular concentrated blend of chemicals provides the basic components of film forming foams for firefighting, which may then be diluted to formulate both concentrated, as well as full strength firefighting foam products.

### SUMMARY OF THE INVENTION

The firefighting compositions of the present invention comprise biodegradable mixtures of 1) an alkali metal alkyl sulfate, 2) a fluorinated polymer, 3) propylene glycol, and 4) water.

### DESCRIPTION OF THE PREFERRED EMBODIMENTS

The present invention provides an improvement over previous firefighting formulations and applications techniques. It has been discovered that a particular concentrated blend of chemicals provides the basic components of film forming foams for firefighting, which may then be diluted to formulate both concentrated, as well as full strength firefighting foam products.

In its most basic form, the composition of the present invention comprises a soluent, (organic solvent) anti-freeze, a surfactant, and a film forming agent. The end product produces a fire fighting foam which at full strength will not freeze, and remains effective over a broad range of temperatures. The amount of blended chemicals, as well as the type of chemicals used produce an end product which minimizes the environmental impact of the product itself, and will not chemically burn or cause harm to firefighters.

In a preferred embodiment, the composition of the present invention is as follows:

| | Approximate Weight Percentages |
|---|---|
| Water | 45-85% |
| Propylene Glycol | 15-45% |
| Sodium Octyl Sulfate | 0.45-1.8% |
| Fluorinated Polymer (telomerized) | 0.1-0.5% |

Note that the above formula refers to sodium octyl sulfate as a total percent of active ions in the concentrated formula; the fluorinated polymers are expressed as a percent of the total concentrated formula, and may be, e.g., either single or multiple carbon chain formulations of fluorinated polymers, more specific details of which may be found in U.S. Pat. No. 5,207,932 and PCT Application WO 96/33777, herein incorporated by reference. In a particularly preferred embodiment of the present invention, the composition is blended in the following order: 1) water, followed by 2) propylene glycol, 3) sodium octyl sulfate, and 4) fluorinated polymer. This particular blend order promotes maximum stability. The present invention thus provides an effective base formula for film forming capabilities and contact extinguishment.

The composition of the present invention provides a full strength firefighting foam that will not freeze, and remains effective over a broad range of temperatures, e.g., about −30° F. (−35° C.) to about 120° F. (49° C.).

In the testing of the present invention, it has been found that the particular composition is a strong contact extinguishing agent. In use, the composition may be applied directly to a burning material. Once the fire has been extinguished, foam can continue to be applied, in order to create a durable, long-lasting foam blanket, which prevents reignition of the extinguished fire. This particular aspect is important where hydrocarbons and their vapors are present. The foam creates an effective barrier to potentially explosive hyrdocarbon vapors. In further testing of the present invention, it has been found that the foam is effective on both aerated and non-aerated materials.

Note that the chemicals used in the composition of the present invention are all readily biodegradable. The amounts of materials present in the composition of the present invention also minimize impact of any particular material on the environment, as well as on firefighting personnel who may come into contact with the foam. The antifreeze material chosen for the composition of the present invention, propylene glycol, rather than e.g., ethylene glycol, also provides a more favorable environmental result, as well as enhancing firefighter safety. Also note that the amount of fluorinated polymer is minimized, due to its interaction with the sodium octyl sulfate, a preferred material in the composition. Through the use of sodium octyl sulfate, the number of available free ions to bond with the fluorinated polymer is greater than that compared to other sodium based surfactants. The composition of the present invention also provides a superior vapor protection, which in turn provides the firefighter with a visible and durable foam blanket that surpresses hydrocarbon vapors and prevents reignition. Thus, the time needed to extinguish a fire is substantially reduced through the use of the composition of the present invention, thereby leaving the firefighter at risk for a significantly shorter period of time.

A series of performance tests were conducted evaluating the effectiveness of the treatment of the present invention in the protection against fuel dispenser sump pan fires. The fire suppression system was evaluated in a simulated fuel dispensing sump enclosure. Two gasoline spill scenarios were simulated, with one evaluating the system's performance against a standing pool fire, and the other evaluating the system's performance against a simulated spill fire.

A series of two tests, simulating a standing pool fire scenario, was conducted. In both cases, a one gallon standing pool was introduced into the confined space of a simulated fuel sump. In both cases, the extinguishing system actuated within three seconds of ignition, and extinguished the flames virtually instantaneously (extinguishment was achieved instantaneously in virtually all tests of the series).

Reignition of the fuel surface was attempted at various times following the initial extinguishment of the fuel surface. A lighted torch was passed across the surface of the undisturbed fuel blanket about 20 minutes following the initial discharge. In both tests, the foam blanket remained intact, and did not allow reignition of the fuel surface after several repeated attempts.

In addition, a series of two tests, simulating a flammable liquid spill/ignition scenario was conducted. In both cases, a one-quart fuel packet was ignited and allowed to spill from the opening of the dispenser sump. In both cases, the extinguishing system actuated within 18 seconds of ignition (actuation occurred as early as seven seconds in one test of the series). Flames were extinguished within six seconds of actuation (extinguishment was achieved virtually instantaneously during one test of the series). Note that in all cases, the unit was filled prior to each test with forty ounces of the composition of the present invention, with the following relative amounts of components: 58.8% water, 40% propylene glycol, 1% sodium octyl sulfate and 0.2% fluorinated polymer, the composition being a freeze-protected, pre-mixed foam solution. Once filled, the suppression system was charged with nitrogen, to 125 psi as evidenced on a liquid pressure gauge provided on the manifold. The unit was then inverted, and mounted within the fuel sump. The charging and installation procedure used was consistent with proposed field installation.

Thus, the suppression system successfully extinguished both standing and spill fires in the tested, enclosed spaces. The agent and delivery system also minimized the propensity for reignition of the fuel surface of standing fuel pools, following initial extinguishment.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

We claim:

1. A foamable firefighting concentrate composition comprising a biodegradable mixture of an alkali metal alkyl sulfate, a fluorinated polymer, propylene glycol and water, said composition being distributable on a fire.

2. The composition as recited in claim 1 wherein said alkali metal alkyl sulfate is sodium octyl sulfate.

3. The composition as recited in claim 1, wherein about 45-85 weight percent of water is present in the final mixture.

4. The composition as recited in claim 1, wherein about 15-45 weight percent of propylene glycol is present in the final mixture.

5. The composition as recited in claim 2, wherein about 0.45-1.8 weight percent of sodium octyl sulfate is present in the final mixture.

6. The composition as recited in claim 1, wherein about 0.1-0.5 weight percent of fluorinated polymer is present in the final mixture.

7. The composition as recited in claim 1, wherein said mixture is effective from about −30° F. to 120° F.

8. A method of preparing a stable, firefighting foam composition comprising combining effective amounts of water, followed by a) propylene glycol, b) an alkali metal alkyl sulfate and c) a fluorinated polymer, to form a final, stable mixture of materials.

9. The method as recited in claim 8, wherein said alkali metal alkyl sulfate is sodium octyl sulfate.

10. The method as recited in claim 8, wherein about 45-85 weight percent of water is present in the final mixture.

11. The method as recited in claim 8, wherein about 15-45 weight percent of propylene glycol is present in the final mixture.

12. The method as recited in claim 9, wherein about 0.45-1.8 weight percent of sodium octyl sulfate is present in the final mixture.

13. The method as recited in claim 8, wherein about 0.1-0.5 weight percent of fluorinated polymer is present in the final mixture.
